(19) United States
(12) Patent Application Publication
(10) Pub. No.: US 2008/0286505 A1
(43) Pub. Date: Nov. 20, 2008

(54) Mica-Reinforced Insulation

(75) Inventors: Bernhard Klaussner, Nurnberg (DE); Willi Lutz, Wolframs-Eschenbach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/094,382

(22) PCT Filed: Oct. 6, 2006
(86) PCT No.: PCT/EP2006/067141

§ 371 Date: May 20, 2008

(30) Foreign Application Priority Data
Nov. 21, 2005 (DE) 10 2005 055 290.0

(51) Int. Cl. B29D 22/00

(52) U.S. Cl. 428/34.1; 156/184

(57) ABSTRACT

Mica-reinforced insulating hose (1) for insulating electrical contact connections with a support hose (2), which has a mica tape (4) surrounding it with one or more layers.

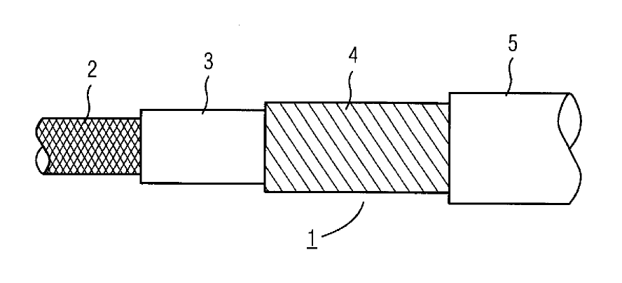

The invention relates to a mica-reinforced insulating sleeve for insulation of electrical contact connections.

Electrical contact connections of electrical equipment, for example between coils of electrical machines or transformers, must be adequately electrically isolated from one another and from ground potential, particularly when using rated voltages above 1 kV. In this case, particularly for electrical equipment in the rated voltage range above 1 kV, the contact connections are insulated by manual winding with mica strips.

For lower rated voltages, that is to say below 1 kV, the insulation in a large number of cases is provided by insulating sleeves, which are known per se.

However, the dielectric strength and the resistance to partial discharge of the insulation are subject to more stringent requirements, with a small wall thickness at the same time, at higher voltages. This requirement can be met only inadequately by unreinforced, painted or extruded insulating sleeves.

The process of manually winding mica strips onto contact connections also results in the risk of the layers of the mica strips being moved during fitting, with the dielectric strength being reduced as a consequence of this, during operation of this electrical equipment.

In order to avoid this disadvantage, the manual winding process can also be carried out only after final shaping of the contact connections.

U.S. Pat. No. 2,772,696 discloses a sleeve which contains mica and is produced in a complex manner by means of liquid components and impregnation and partial curing.

JP 1160339 A2 discloses a sleeve which contains mica and has a plurality of layers, with the inner layer being composed of strips which contain mica and being adjacent to a resin coating which is surrounded by a shrink sleeve.

In order in this case to provide insulation which contains mica in each case it is necessary to use extremely complex production methods and, in order to achieve the required dielectric strength, the resulting products in this case have a sleeve with corresponding wall thicknesses. This leads to manufacturing problems, particularly in the case of relatively high rated voltages (above 1 kV). The sleeves have very little flexibility and therefore have a very restricted bending radius.

Against this background, the invention is based on the object of providing insulation which is simple to produce and has thin walls, in particular for contact connections for electrical equipment with rated voltages above 1 kV. Furthermore, the insulation should be flexible in order to allow corresponding contact connections to be insulated, with adequate dielectric strength, as well.

The stated object is achieved by a mica-reinforced insulating sleeve for insulation of electrical contact connections having a mount sleeve which has a mica strip spun around it in one or more layers.

However, the stated object is also achieved by a method for production of a mica-reinforced insulating sleeve, characterized by the following steps:
a mount sleeve is widened by compressed air and/or a mandrel to a desired internal diameter,
a mica strip is spun around the mount sleeve that is in this state,
in this case, the overlap and/or the number of layers of the mica strip are/is adjustable.

This mica-reinforced insulation according to the invention is distinguished by a layered structure which, according to the invention, is characterized by a mount sleeve and mica materials located on it. The use of one or more layers of a mica binding with an adjustable overlap makes it possible to match the dielectric strength and the partial discharge resistance to the respective voltage requirements. These requirements are both the rated voltage loads and the overvoltage effects to be expected during converter operation of electrical machines, or resulting from overvoltages caused by power supply system anomalies, such as lightning strikes or traveling-wave effects on electrical lines and cables.

For example, the layered structure may be produced by spinning a coating composed of mica strip around a fabric sleeve, which is woven, knitted or laced. Furthermore, continuous, that is to say integral, sleeves with a coating of PU, acrylate or silicone can likewise have a mica strip wound around them in order to provide a mica-reinforced insulating sleeve for insulation of electrical contact connections.

Mica is an inorganic insulating material and, comparatively, has very good electrical insulation and thermal characteristics. It also has very good creepage-current and breakdown resistance. The dielectric constant ∈ᵣ is between 5 and 8.

A mica strip has small mica pieces which are adhesively bonded using a binding agent, and are pressed under the influence of heat. The density of the mica pieces directly influences the electrical insulation characteristics.

This porous mica strip advantageously has an accelerator which in this way assists in curing of the impregnation resin in the mount sleeve.

In a further advantageous refinement, the mica-reinforced insulating sleeve is provided with mechanical protection composed of a fiber mesh, which may be a glass fiber or plastic fiber.

The mica-reinforced insulating sleeve according to the invention is in one preferred embodiment produced by the following steps: the mount sleeve is widened to the desired internal diameter by means of compressed air and/or by means of a mandrel, and a mica strip is spun around it in this state.

These two or three process steps, production of the mount sleeve followed by the mica strip being spun around it and possibly application of a mechanical protection sleeve or protection mesh, can advantageously be carried out by means of one apparatus or in one process step.

The mica component increases the dielectric strength and the partial discharge resistance of the insulation even with thin walls above those of unreinforced painted or extruded insulating sleeves.

The mechanical strength and flexibility are considerably greater than those of conventional rolled small mica strip rolls or tubes, for example as a result of the fabric reinforcement of the mount sleeve. This also prevents movement of the layers of the mica strip, particularly while other parts are being fitted, thus making it possible to ensure the dielectric strength of the electrical equipment. The insulation according to the invention also makes it possible to make contact in the rated voltage range above 1 kV resistant to partial discharges, in a simple manner.

In this case, these sleeves which have now been formed are pushed over the respective points to be insulated in the respective electrical equipment, such as electrical machines, converters or transformers, without any need to be concerned that the existing layers of the insulation will change their position.

The insulation is therefore applied before the final shaping of the contact connection, and withstands the mechanical loads during this shaping process.

The production of electrical machines is also considerably simplified since, during the production process, the prefabricated flexible insulating sleeves according to the invention can easily be pushed over the contact connections to be insulated and can then be impregnated together with the entire electrical machine.

The invention as well as further advantageous refinements of the invention according to features of the dependent claims will be explained in more detail in the following text with reference to a schematically illustrated exemplary embodiment.

The FIGURE shows a section of an insulating sleeve 1 according to the invention whose base is formed by a woven glass sleeve which is in the form of a mount sleeve 2. This woven glass sleeve 2 is surrounded by a casing 3 composed, for example, of LSR (Liquid Silicon Rubber). This casing 3 is, for example, formed from liquid silicone rubber. This arrangement is now surrounded by a mica strip 4 which results in a mica layer of defined layer thickness, by means of a predetermined number of layers and/or a predeterminable overlap of the individual layers. The respective mica strips 4 advantageously each have a defined layer thickness and/or layer width. PET (Poly-Ethylene-Terephthalate) fiber mesh 5 is particularly suitable for mechanical protection.

The production process is carried out in an appropriately designed apparatus, which can apply the individual layers in a defined manner. The manufacturing steps are advantageously carried out in one apparatus. In this case, a woven, knitted or laced mount sleeve 2 composed of glass fibers or synthetic fibers is widened to the desired internal diameter, for example by means of compressed air.

As an alternative to this, the mount sleeve 2 can also be widened using a mandrel of appropriate size.

In a further embodiment, the mount sleeve 2 is provided with a casing 3 composed of PU, acrylate or silicone, before the next method step.

The mount sleeve 2 now has the mica strip 4 spun around it, in this state. The mica strip 4 is porous and advantageously contains an accelerator in order in this way to assist the curing of an impregnation resin in the mount sleeve 2.

The mica component of the mount sleeve 2 is varied and therefore set in places in a predeterminable manner, by means of the overlap of the mica strip 4 during the spinning process.

The mount sleeve 2 with the mica strip spun around it is advantageously provided with a fiber mesh 5 composed of glass fibers or plastic fibers, as mechanical protection.

The mica component increases the dielectric strength and the partial discharge resistance of the insulating sleeve 1 in comparison to a sleeve which is painted or extruded, and has comparatively thin walls.

The mechanical strength and flexibility in comparison to conventional rolled small mica strip rolls or tubes are considerably increased, inter alia, by the fabric reinforcement of the mount sleeve 2, in comparison to other insulating sleeves.

Furthermore, this prevents movement of the layers of the mica strip 4 in particular when other parts of the electrical equipment are being fitted, so that the dielectric strength of the electrical equipment, for example of an electrical machine, can be ensured.

The mica-reinforced insulating sleeve 1 according to the invention has at least one mount sleeve 2 with a mica strip 4 spun around it. A casing 3 and/or a fiber mesh 5 are provided in further embodiments.

1.-12. (canceled)

13. A mica-reinforced insulating sleeve for insulation of an electrical contact connection, comprising:
a mount sleeve made of fabric which is woven, knitted or laced and formed from glass or synthetic fibers; and
a mica strip in surrounding relationship to the mount sleeve in one or more layers.

14. The mica-reinforced insulating sleeve of claim 13, further comprising a fiber mesh made of glass fibers or plastic fibers and placed in surrounding relationship to the mica strip for mechanical protection.

15. The mica-reinforced insulating sleeve of claim 13, further comprising a sleeve placed in surrounding relationship to the mica strip.

16. A mica-reinforced insulating sleeve for insulation of an electrical contact connection, comprising:
a mount sleeve in the form of a closed single-piece sleeve which has a casing composed of Pu, acrylate or silicone; and
a mica strip in surrounding relationship to the mount sleeve in one or more layers.

17. The mica-reinforced insulating sleeve of claim 16, further comprising a fiber mesh made of glass fibers or plastic fibers and placed in surrounding relationship to the mica strip for mechanical protection.

18. The mica-reinforced insulating sleeve of claim 16, further comprising a sleeve placed in surrounding relationship to the mica strip.

19. A method for production of a mica-reinforced insulating sleeve, comprising the steps of:
widening a mount sleeve by compressed air and/or a mandrel to a desired internal diameter; and
spinning at least one mica strip around the mount sleeve in such a manner as to adjust an overlap and/or a number of layers of the mica strip on the mount sleeve.

20. The method of claim 19, further comprising the step of applying a fiber mesh of glass fibers or plastic fibers as mechanical protection around the mica strip which has been spun around the mount sleeve.

21. The method of claim 20, further comprising the step of immersing the fiber mesh in silicone.

22. The method of claim 19, further comprising the step of applying the insulating sleeve over an electrical contact connection of an electrical equipment for providing a mica-reinforced insulation of the contact connection.

23. The method of claim 22, wherein the electrical equipment operates at a rated voltage of more than 1 kV.

24. The method of claim 22, wherein the electrical equipment is a member selected from the group consisting of converter, transformer, and electrical machine.

25. A method of making an electrical machine, comprising the steps of:
stacking laminations for making a member selected from the group consisting of stator and rotor;
inserting coils into the member;
forming circuit connections between the coils and optional converters; and
pushing over the circuit connections a mica-reinforced insulating sleeve comprised of a mount sleeve made of fabric which is woven, knitted or laced and formed from glass or synthetic fibers, and a mica strip in surrounding relationship to the mount sleeve in one or more layers.
